(19) United States
(12) Patent Application Publication
(10) Pub. No.: US 2016/0087837 A1
(43) Pub. Date: Mar. 24, 2016

(54) DEVICE FOR MANAGING AND CONFIGURING FIELD DEVICES IN AN AUTOMATION INSTALLATION

(71) Applicant: ABB TECHNOLOGY AG, Zuerich (CH)

(72) Inventors: Dirk Wagener, Stadthagen (DE); Christoph Welte, Neu-Ulm (DE); Marcus Heege, Kaisersesch (DE); Wolfgang Mahnke, Hettenleidelheim (DE); Marko Schlueter, Espelkamp (DE)

(21) Appl. No.: 14/856,754

(22) Filed: Sep. 17, 2015

(30) Foreign Application Priority Data
Sep. 19, 2014 (DE) 10 2014 013 964.6

(51) Int. Cl. H04L 12/24

(52) U.S. Cl. CPC H04L 41/0806

(57) ABSTRACT

A device for managing and configuring field devices in an automation installation with a configuration tool that is designed to physically detect a field device in the automation installation, to logically incorporate it into the automation installation and to configure it in the automation installation, the configuration tool communicating with the field devices and ascertaining the device status thereof on a regular cycle. In order to visualize the validity of a device status ascertained in the past, each field device may have, in the configuration tool, an associated device status symbol whose appearance changes dynamically on the basis of the time elapsed (t₁, t₂, t₃) since the time (t₀) of the last update of the device status.

### CROSS-REFERENCE TO RELATED APPLICATIONS

Priority is claimed to German Patent Application No. DE 10 2014 013 964.6, filed on Sep. 19, 2014, the entire disclosure of which is hereby incorporated by reference herein.

### FIELD

The invention relates to a method and a device for managing and configuring field devices in an automation installation.

### BACKGROUND

Automation systems for controlling a technical process or a technical installation usually comprise a control device (PLC) which is integrated in a group of a multiplicity of intelligent electrical devices. Intelligent electronic devices are microprocessor-based devices, for example protective and control devices, motor protective devices, intelligent switches and voltage regulators, frequency converters, pressure and temperature measuring transducers, flowmeters and actuators.

The article “FDI Device Integration—Best of Both Worlds”, atp edition 6/2010, pages 16 to 19, discloses the practice of integrating field devices into an automation installation using the FDI concept (Field Device Integration IEC-62769). The basis of this concept is the provision of information for configuring field devices in a device-specific FDI packet. This FDI packet comprises a firmly predefined amount of information which consists of a device definition, business logic, a user interface description and user interface plug-ins. The device definition comprises management information and the device model. The business logic describes the communication logic for the device and is used to ensure consistency of the device model. The user interface description describes the presentation of the device parameters and device functions. The user interface plug-ins are programmed components of interface portions for displaying the device parameters and functions.

When configuring field devices by means of EDD (electronic device description) technology IEC 61804, a device manufacturer provides an EDD which comprises information relating to the communication with the device, the business logic and the user interfaces, that is to say which input masks should be displayed for a user. The business logic includes, for example, when which parameters can be written.

FDI technology uses these EDD mechanisms and provides the concept of the FDI package which, in addition to an EDD, may also include other information such as a user handbook or else so-called UIPs (user interface plug-in) which provide further user interfaces in other technologies, for example .NET assemblies, which, in contrast to EDD-based user interfaces, consist of programmed code compiled for a component.

FDI packets are typically created by device manufacturers and are used by system manufacturers to integrate and configure the devices from the device manufacturers in their system.

In addition to an individual user element having different parameters, graphs and other elements, new windows and dialogs may also be defined in the EDD. In this case, a host has certain freedoms and can display a plurality of menus defined in the EDD in different windows at the same time, for example, or else user interfaces of different device entities.

In such a programming tool, information relating to the devices is visualized and functions, such as parameter setting, are executed. For this purpose, the user first needs to select a device from a multiplicity of devices.

Furthermore, in known programming tools, the same device is disadvantageously represented in various ways. Thus, a different device object and symbol is displayed in the tree structure than in the list representation of the devices. The device functionality also differs based on the display format. The display is not consistent and is therefore difficult for a user to learn. The different displays also differ with respect to device functionalities which the user can execute. Thus, the user cannot execute the same device functions in the list representation as if he chose the device object in the tree. The user must therefore know which device functions he can find and execute in which display.

A screen element, HMI device, automation system and computer program product for visualizing and projecting user texts which are used once and more than once and the associated points of use in a data processing system are known from DE 102 45 890 B4. What can be gathered from the disclosure is that the devices are provided for selection in a hierarchical tree structure, wherein a user text is associated with each branch which branches further and a combination of a user text and a point of use is associated with each branch which does not branch further. Details relating to a device are stored in nested menu levels. Hence, the operation and, in particular, the search for details relating to a device becomes a time-consuming process.

Known configuration tools indicate the status of a device by means of different symbols and/or colors. By way of example, the color red can indicate that a device is not connected or has an error and the device configuration software cannot interchange data with the device. Often, these symbols and colors are based on standards such as NAMUR NE108, for example.

The procedure for how the device configuration software gets to the status or reads the status is different in known configuration tools. Some programs communicate with the devices at regular intervals and in this way obtain the required information for ascertaining and indicating the status. Other programs indicate the device status only as soon as the device is used and there is communication with the device.

Specifically in the case of devices with the HART communication interface, the data transmission for the device-specific parameters is very slow in comparison with today's user expectations in respect of speed. The querying of device data measured from start to end takes a few seconds on average. When special device queries are executed, it can also take several minutes before the complete query is at an end. During this time, the status is not always up to date in the prior art today; the device may already have a different status than displayed by the device configuration software.

The user is unable to tell how old the device status is from the device status representation in the device configuration software, and he is therefore unable to assess whether or not a status change might have taken place.

### SUMMARY

An aspect of the invention provides a device for managing and configuring one or more field devices in an automation installation, the device comprising: a configuration tool designed to physically detect a field device in the automation installation, to logically incorporate the field device into the automation installation, and to configure the field device in the automation installation, wherein the configuration tool communicates with the field devices and ascertains a device status thereof on a regular cycle, wherein, each field device includes, in the configuration tool, an associated device status symbol, wherein an associated device symbol appearance changes dynamically based on time elapsed (t₁, t₂, t₃) since a last update time (t₀) of the device status.

### BRIEF DESCRIPTION OF THE DRAWINGS

The present invention will be described in even greater detail below based on the exemplary FIGURES. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

### DETAILED DESCRIPTION

The invention relates to a method and a device for managing and configuring field devices in an automation installation, which can be used, in particular, in process automation or machine control for controlling processes and/or installation components.

Therefore, the invention is based on the object of specifying a device for managing and configuring field devices in an automation installation that visualizes the validity of a device status ascertained in the past.

According to the invention, this object is achieved by means of the features of claim 1. Advantageous configurations of the invention are specified in the dependent claims.

The invention is based on a device for managing and configuring field devices in an automation installation with a configuration tool that is designed to physically detect a field device in the automation installation, to logically incorporate it into the automation installation and to configure it in the automation installation, the configuration tool communicating with the field devices and ascertaining the device status thereof on a regular cycle.

The invention provides for each field device to have, in the configuration tool, an associated device status symbol whose appearance changes dynamically on the basis of the time elapsed since the last update of the device status.

Advantageously, this dynamic change of appearance provides the age of the indicated device status and hence an indication of the probability of the validity of the device status at the time of observation.

The display of the device status symbol thus indicates the age of the indicated device status, with the currentness and hence the probability of the validity of the device status decreasing as the age increases. Hence, the user is rendered able to assess whether a status change for the device could have occurred or whether it is more probable that the status of the device is still valid.

According to a further feature of the invention, the device status symbol has a clock that indicates the time of the last update of the device status.

In this way, it is immediately possible to ascertain the time difference between the time of the last update of the device status and the present time on a device-individual basis.

According to a further feature of the invention, the contrast of the clock with respect to the background is displayed dynamically. In particular, provision may be made for the contrast of the clock to be set in a manner inversely proportional to the currentness of the device status.

As time progresses and there is an accompanying decrease in the currentness of the device status, the clock of the device status symbol fades. This can take place smoothly or in stages. Thus, provision may also be made for the clock to be hidden after a prescribed period of time has elapsed since the last update of the device status, and hence to symbolize that the validity of the indicated device status has left the realm of trustworthiness.

According to a further feature of the invention, the device status symbol has an associated two-dimensional geometric figure whose area content is dynamically split into two subareas of different color, the area ratio of which is dependent on the elapsed period of time since the last update of the device status. In this case, the area ratio symbolizes a fill level and is thus a measure of the validity and/or trustworthiness of the indicated device status.

According to a further feature of the invention, the contrast of the geometric figure with respect to the background is displayed dynamically. In this case, provision may be made for the contrast of the geometric figure to be set in a manner inversely proportional to the currentness of the device status. In particular, provision may be made for the geometric figure to be hidden after a prescribed period of time has elapsed since the last update of the device status. This symbolizes that the validity of the indicated device status has left the realm of trustworthiness.

The invention is explained in more detail below using exemplary embodiments. The single FIGURE shows a timing diagram with which the dynamic state of a device status symbol 1 is associated at selected times t₀, t₁, t₂, t₃.

The time t₀ denotes the time of the update of the device status. The further times t₁, t₂, t₃ show changes of the device status symbol 1 over the time.

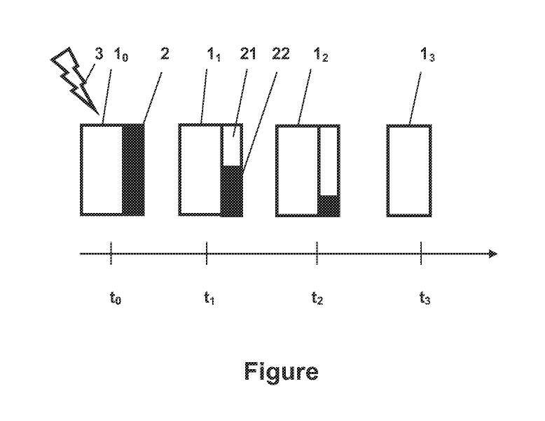

The device status symbol 1 has an associated two-dimensional geometric figure 2 in the form of a rectangle, the area content of which is dynamically split into two subareas 21, 22 that have different colors to allow them to be distinguished. In the FIGURE, the filled black subarea 22 indicates the measure of the validity and/or trustworthiness of the indicated device status. The unfilled white subarea 21 indicates the degree of invalidity. The area ratio of the subareas 21, 22 is dependent on the elapsed time since the last update 3 of the device status at the time t₀.

In the further display, the indices of the device status symbol 1 follow the indices of the selected times t₀, t₁, t₂, t₃. The device status symbol lₒ shows the device state at the time t₀, that is to say at the time of the update 3 of the device status. In this state, the elapsed period of time since the last update 3 of the device status is equal to zero and the rectangle 2 is filled with black. The area content of the unfilled subarea 21 is zero. Hence, the device status has maximum validity and/or trustworthiness.

At the time t₁, the device status symbol 1₁ indicates limited validity and/or trustworthiness of the device status. At this time t₁, a period of time t₁-t₀ has already elapsed since the last update 3 of the device status. The area content of the filled black subarea 22 is smaller in comparison with the device status symbol 1₀ at the time t₀, while the area content of the unfilled subarea 21 has increased.

At the time t₂, the device status symbol 1₂ indicates even more limited validity and/or trustworthiness of the device status. At this time t₂, in comparison with the time t₁, a further period of time t₂-t₀>t₁-t₀ has already elapsed since the last update 3 of the device status. The area content of the filled black subarea 22 is smaller in comparison with the device status symbol 1₁ at the time t₁, while the area content of the unfilled subarea 21 has increased.

At the time t₃, the device status symbol 1₃ indicates a device status whose validity and/or trustworthiness is inclined towards zero. In this case, the contrast of the rectangle 2 with respect to the background has reduced dynamically. The rectangle 2 is hidden.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

### LIST OF REFERENCE SYMBOLS

1x device status symbol

2 geometric figure, rectangle

21, 22 subarea

3 update

tx time

1. A device for managing and configuring a plurality of field devices in an automation installation, the device comprising:
a configuration tool configured to physically detect one of the plurality of field devices in the automation installation, to logically incorporate the detected field device into the automation installation, and to configure the detected field device in the automation installation,
wherein the configuration tool communicates with the field devices and ascertains a device status of each field device on a regular cycle,
wherein, each field device includes, in the configuration tool, an associated device status symbol,
wherein an associated device symbol appearance changes dynamically based on time elapsed (t₁, t₂, t₃) since a last update time (t₀) of the device status.

2. The device of claim 1, wherein the device status symbol includes a clock that indicates the last update time of the device status.

3. The device of claim 2, wherein a contrast of the clock with respect to a background is displayed dynamically.

4. The device of claim 3, wherein the contrast of the clock is inversely proportional to a currentness of the device status.

5. The device of claim 1, wherein the device status symbol includes an associated two-dimensional geometric figure.
wherein an area content of the associated two-dimensional geometric figure is dynamically split into two subareas of different color, and
wherein an area ratio of the two subareas is dependent on an elapsed time period since a last update of the device status.

6. The device of claim 5, wherein a contrast of the associated two-dimensional geometric figure with respect to a background is displayed dynamically.

7. The device of claim 6, wherein the contrast of the associated two-dimensional geometric figure is inversely proportional to a currentness of the device status.
